(19) United States
(12) Patent Application Publication
(10) Pub. No.: US 2009/0067086 A1
(43) Pub. Date: Mar. 12, 2009

(54) STORAGE DEVICE

(75) Inventors: Hisashi Kaneko, Kawasaki (JP); Yoshiharu Matsuda, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/175,051

(22) Filed: Jul. 17, 2008

(30) Foreign Application Priority Data
Sep. 10, 2007 (JP) 2007-234282

(51) Int. Cl. G11B 5/012

(52) U.S. Cl. 360/98.01

(57) ABSTRACT

A storage device includes plural recording media, a housing configured to accommodate the plural recording media, a plate that is fixed and extends round between two adjacent recording media in the housing, plural sliders each of which is mounted with a magnetic head that is configured to record information in or reproduce the information from a corresponding one of the plural recording media, and plural arms, each of which is mounted with one of the plural sliders only on a single surface, and configured to move the one of the plural sliders.

### BACKGROUND OF THE INVENTION

1. Field of the Invention

The present invention relates to a storage device, such as a hard disc drive (“HDD”), and more particularly to a storage device that arranges a vibration resistance member between two adjacent recording media.

2. Description of the Related Art

In order to meet the recent high-capacity demand, the HDD houses plural magnetic discs and improves the recording density of each disc. Along with the high recording density of the disc, a magnetic head that records information in and reproduces the information from the disc is required to have high positioning precision. A slider mounted with the magnetic head is held on an arm that is configured to rotate around a shaft outside of the magnetic disc, and floats over the magnetic disc due to the airflow associated with rotations of the magnetic disc. In loading the slider over the magnetic disc, the arm comes in part of a space between the magnetic discs or part of a space over the disc.

The airflow is necessary to provide a floating force that floats the slider over the magnetic disc, but causes a problem of vibrations of the magnetic disc and slider, which hinders highly precise positioning of the magnetic head. In particular, turbulence may occur between two adjacent discs due to a mixture of the airflows from two opposing disc surfaces. As the head needs higher positioning precision, this negative influence of the airflows is no longer ignored. Accordingly, Japanese Patent Laid-Open Nos. (“JP”) 2005-509232 and 2006-12330 propose that a disc-shaped plate be arranged between two adjacent discs so as to lower the airflow generated in a space held by two adjacent discs, and to reduce the vibrations of the disc and the slider, because the plate shields the airflow from the other disc in that space, and lowers the volume of the space.

Other prior art includes Japanese Patent Laid-Open No. (“JP”) 2004-171713.

Each plate disclosed in JP 2005-509232 and 2006-12330 has a fan-shaped notch in an area in which the arm goes so that its central angle is reduced. The arm that goes in the space between the two magnetic discs has a pair of sliders at both surfaces of the arm, and the notch is necessary to prevent a collision between the arm and the plate. However, the airflow occurs in the notch and vibrates the magnetic discs and sliders. Thus, the notched plates disclosed in JP 2005-509232 and 2006-12330 are insufficient in a vibration reductive or preventive effect.

### SUMMARY OF THE INVENTION

The present invention is directed to a storage device that has a good vibration reductive effect of a recording medium and a slider.

A storage device according to one aspect of the present invention includes plural recording media, a housing configured to accommodate the plural recording media, a plate that is fixed and extends round between two adjacent recording media in the housing, plural sliders each of which is mounted with a magnetic head that is configured to record information in or reproduce the information from a corresponding one of the plural recording media, and plural arms, each of which is mounted with one of the plural sliders only on a single surface, and configured to move the one of the plural sliders. According to this storage device, the plate extends round between two adjacent recording media in the housing, and maintains its central angle of 360° without a notch. Therefore, the plate reduces the space further than JP 2005-509232 and 2006-12330, effectively shields the airflow from the other recording medium, and reduces the vibrations through the reduced airflow. In addition, since each arm is mounted with a slider only on a single surface, the present invention can provide an arrangement between two adjacent recording media in order of a recording media, a slider, an arm, a plate, another arm, another slider, and another recording medium. When each arm is mounted with the slider only on a single surface, the arm can goes in between the recording medium and the plate, and provide recording or reproducing on opposing surfaces of the two adjacent recording media without a notch.

The plate has, for example, a plate shape. This shape facilitates manufacturing, and shields the airflow from the other recording medium.

The plate may have a first area in which the arm goes, and a second area in which the arm does not go. The first area may be thinner than the second area. The second area close to the recording medium can reduce the space between the two adjacent recording media, and reduce the vibrations through the reduced airflow.

The plate may have a projection in the second area, which projection is closest to a corresponding one of the recording media. This configuration needs to maintain the precision only of a distance between the recording medium and the closest part of the second area, and does not need to maintain the precision of a distance between the recording medium and the entire surface of the second area. Therefore, the manufacture becomes easier. The plate may have three cylindrical projections arranged at regular intervals of in the second area.

The plate may have a projecting outer edge (shroud) in the second area. The shroud rectifies the airflow of the end surface of the recording medium, and further restrains the vibrations of the recording medium. Part of the projecting outer edge may have a notch. This notch releases the airflow generated inside the shroud to the outside, maintains the air filter effect, and improves the cooling efficiency of the VCM. The housing may have an exhaust channel that is connected to the notch and encloses part of a corresponding one of the recording media. This configuration facilitates an exhaust of the airflow.

The housing may have an exhaust channel that extends parallel to a tangential direction of each recording media. This configuration facilitates an exhaust of the airflow.

The plate may have a cylindrical perforation hole, and the plate has a projection that extends from the cylindrical perforation hole to an outer circumference. This configuration releases the airflow to the outside, maintains the air filter effect, and improves the cooling efficiency of the VCM. The projection may extend in a tangential direction of the cylindrical perforation hole, because the air flows in this direction.

Further features of the present invention will become apparent from the following description of exemplary embodiments (with reference to the attached drawings).

### BRIEF DESCRIPTION OF THE DRAWINGS

FIG. 1 is a plane view showing an internal structure of a hard disc drive (“HDD”) according to a first embodiment of the present invention.

FIG. 2 is a sectional view of the HDD shown in FIG. 1.

FIG. 3 is a perspective view of a plate shown in FIG. 2.

FIG. 4 is an enlarged perspective view a slider in the HDD shown in FIG. 1.

FIG. 5A is a schematic sectional view of a conventional arm, suspension and slider. FIG. 5B is a schematic sectional view of an arm, suspension and slider according to this embodiment.

FIG. 6 is a plane view showing an internal structure of a HDD according to a second embodiment of the present invention.

FIG. 7 is a sectional view of the HDD shown in FIG. 6.

FIG. 8A is a perspective view of a front side of a plate shown in FIG. 7, and FIG. 8B is a perspective view of a rear side of the plate shown in FIG. 7.

FIG. 9 is a plane view showing an internal structure of a HDD according to a third embodiment of the present invention.

FIG. 10 is a sectional view of the HDD shown in FIG. 9.

FIG. 11A is a perspective view of a front side of a plate shown in FIG. 10, and FIG. 11B is a perspective view of a rear side of the plate shown in FIG. 10.

FIG. 12 is a perspective view of a variation of the plate shown in FIG. 3.

FIG. 13 is a perspective view of a variation of the plate shown in FIG. 11.

### DESCRIPTION OF THE EMBODIMENTS

Referring now to the accompanying drawings, a description will be given of an HDD (magnetic disc drive) as one example of a storage device according to the present invention.

### First Embodiment

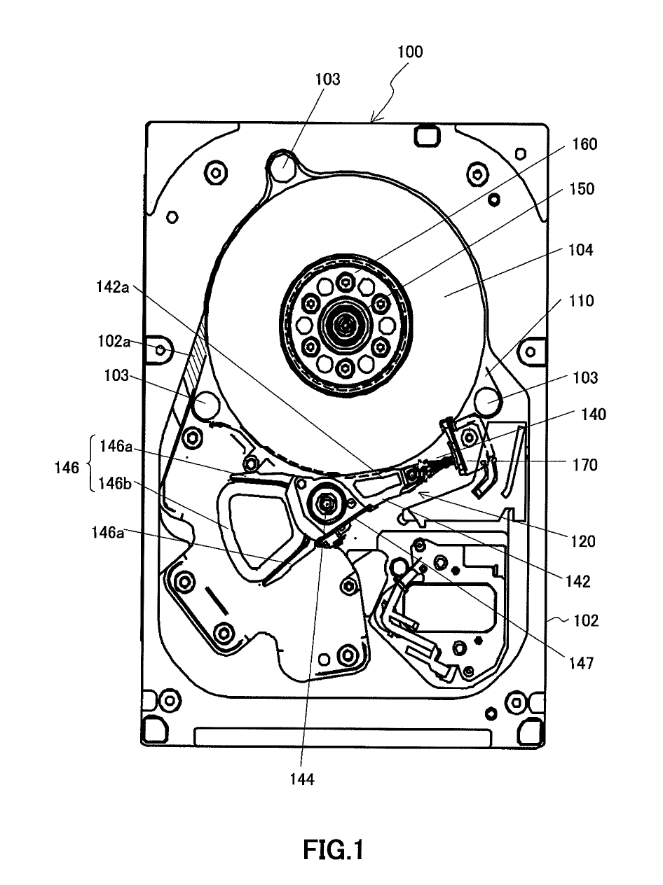

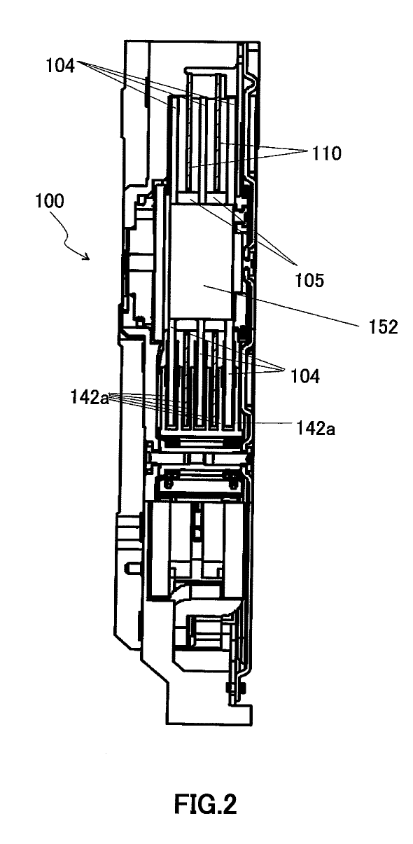

FIG. 1 is a schematic plane view of the internal structure of the HDD 100 according to a first embodiment of the present invention. FIG. 2 is a sectional view of the HDD 100. The HDD 100 includes, in a housing 102 as shown in FIG. 1, plural (three in FIG. 2 in this embodiment) magnetic discs 104 as a magnetic recording medium, a plate 110, a head stack assembly (“HSA”) 120, a spindle motor 150, a clamp ring 160, and a ramp 170.

The housing 102 is made, for example, of aluminum die casting or stainless steel, and has a rectangular parallelepiped shape to which a cover (not shown) is coupled so as to seal its internal space. The housing 102 has an exhaust channel 102a of the airflow, which is hatched in FIG. 1. In a direction perpendicular to the paper plane shown in FIG. 1, the exhaust channel 102a has a height from a magnetic disc 104 located at the uppermost position shown in FIG. 2 to a magnetic disc 104 located at the lowermost position, and extends in a direction parallel to a tangent of the plate 110 or magnetic disc 104. The exhaust channel 102a facilitates an exhaust of the airflow, as described later, which airflow occurs in the space between two adjacent magnetic discs 104.

The magnetic disc 104 of this embodiment has a high recording density of 100 Gb/in² or higher. A magnetic head is required to have a high positioning function for the magnetic disc with such a high surface recording density. The magnetic discs 104 are mounted on a spindle (hub) 152 of the spindle motor 150 through their central perforation holes. An annular spacer 105 spaces two adjacent magnetic discs 104 mounted on the spindle 152. The magnetic disc 104 rotates with the spindle 152.

Each plate 110 is arranged between the two adjacent magnetic discs 104, reduces the volume of a space between the two adjacent magnetic discs 104, and shields the airflow which one magnetic disc 104 generates from the airflow which the other magnetic disc 104 generates. The generated airflow reduces by reducing the volume of the space between the two adjacent magnetic discs 104, and the turbulence is prevented by preventing a mixture of the airflows. As a result, this configuration reduces or prevents vibrations of the magnetic discs 104 and the sliders 130 of the HSA 120, which will be described later. Since this embodiment provides three magnetic discs 104 as shown in FIG. 2, two plates 110 are provided.

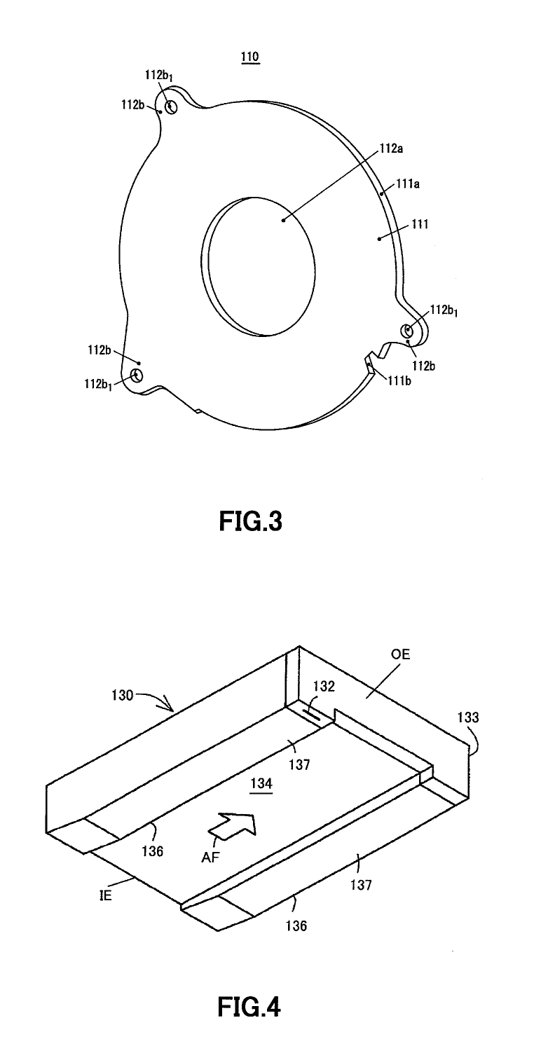

The plate 110 is fixed in the housing 102 via three screws 103, and maintained stationary relative to the rotating magnetic disc 104. The centers of the three screws 103 are arranged at regular intervals of 120° on the same circumference. FIG. 3 is a perspective view of the plate 110. The plate 110 has a disc shape. The plate 110 has an annular base 111, a perforation hole 112a having a thin cylindrical shape, and three attachment parts 112b.

The base 111 has a constant thickness, and possesses the perforation hole 112a at the center. The base 111 of the plate 110 of this embodiment has a plate shape, and a manufacture is easy. Part of an outer circumference 111a of the base 111 has a recess 111b into which the ramp 170 projects. The perforation hole 112a is arranged around the spacer 105. The three attachment parts 112b are approximately triangular projections that project to the outside in radial directions from the outer circumference 111a of the base 111, and have three attachment holes 112b₁ into each of which the screw 103 perforates. The centers of the attachment holes 112b₁ are arranged at regular intervals of 120° on the same circumference.

The plate 110 is arranged and extends round between the two adjacent magnetic discs 104. A phrase “extends round” means that there is no connection notch that connects the perforation hole 112a to the outer circumference 111a of the base 111 or the plate maintains the central angle of 360°. JP 2005-509232 and 2006-12330 provides the connection notch in the plate so that the arm 142a and the suspension 140 can go in the notch. On the other hand, this embodiment eliminates such a notch by modifying a connection structure of the arm 142a and the suspension 140. The plate 110 covers an area of the conventional notch in JP 2005-509232 and 2006-12330, lowers the volume in the space between the two adjacent magnetic discs 104 further than JP 2005-509232 and 2006-12330, and improves a ratio by which the airflow which one magnetic disc 104 generates does not mix with the airflow which the other magnetic disc 104 generates. As a result, this configuration can effectively reduce or prevent vibrations of the magnetic discs 104 and the sliders 130 of the HSA 120, which will be described later.

The HSA 120 includes plural (six in this embodiment) sliders 130, plural (six in this embodiment) suspensions 140, and a carriage 142.

The slider 130 has, as shown in FIG. 4, an approximately rectangular parallelepiped shape made of Al₂O₃—TiC (altic), and a head-device built-in film 133 that is united with at an air outflow end OE, made of Al₂O₃ (alumina), and provided with a read/write magnetic head 132. FIG. 4 is an enlarged perspective view of the slider 130. The slider 130 defines a floatation surface 134 as a surface opposite to a medium, i.e., the magnetic disc 104, for receiving air current AF generated from the rotating magnetic disc 104.

A pair of rails 136 are formed on the floatation surface 134, extending from an air inflow end IE to the air outflow end OE. A so-called air-bearing surface (referred to as “ABS” hereinafter) 127 is defined at a top surface of each rail 136. The floating force is generated on the ABS 127 according to an act of the air current AF. In the two adjacent magnetic discs 104, the airflow AF, which is generated from the other magnetic disc 104 different from the magnetic disc 104 opposite to the floatation surface 134, becomes turbulence, and causes vibrations of the slider 130. In addition, a wide space also causes the turbulence, in which the airflow AF is generated from the magnetic disc 104 opposite to the floatation surface 134.

The magnetic head 132 embedded in the head-device built-in film 133 exposes on the ABS 127. The driving system of this embodiment uses a dynamic or ramp loading system that picks up the slider 130 from the disc 104 at the stop time, holds the slider 130 on the ramp 170 located outside the disc 104 in a non-contact manner, and drops the slider 130 from the ramp 170 over the disc 104 at the driving time.

The head 132 includes, for example, a magnetoresistive (“MR” hereinafter)/inductive composite head that contains an inductive head device for writing binary information into the magnetic disc 104 using a magnetic field induced by a conductive coil pattern (not shown), and a MR head device for reading resistance as binary information changing according to a magnetic field generated by the magnetic disc 104. The MR head device may use any type, such as a Current in Plane (“CIP”) structure, a Current Perpendicular to Plane (“CPP”) structure, and a tunneling magnetoresistive type (“TMR”).

The suspension 140 supports the slider 130 and applies an elastic force to the slider 130 against the magnetic disc 104. The suspension 140 has a flexure (also referred to as a gimbal spring or another name) configured to cantilever the slider 130, and a load beam (also referred to as a load arm or another name) connected to a base plate. The suspension 140 has a wiring part (not shown) that is connected to the slider 130 via a lead wire. The sense current, read-in data, and read-out data are supplied and output between the magnetic head 132 and the wiring part through the lead wire.

The carriage 142 can rotate or swing around a support shaft 144 by a voice coil motor (“VCM”) 146. The carriage 142 is referred to as an actuator, an E block (because it has an E-shaped section), or an actuator (AC) block. The carriage 142 is provided with a flexible circuit (“FPC”) board 147 that supplies a control signal to the slider 130, a signal to be recorded on the disc 104, supplies power, and receives a signal reproduced from the disc 104.

The carriage 142 has plural arms 142a each of which is connected to a corresponding one of suspensions 140 via the base plate. The arm 142a is an aluminum rigid member that is configured to rotate or swing around the support shaft 144.

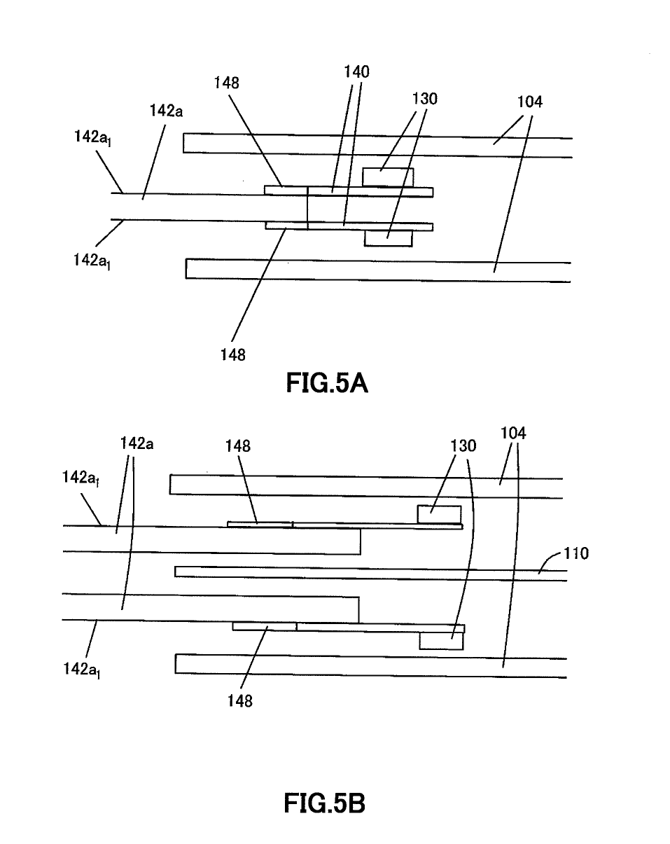

FIG. 5A is a schematic sectional view of the conventional structure of the arm 142a, the suspension 140, and the slider 130 arranged between the two adjacent magnetic discs 104. As shown in FIG. 5A, conventionally, bosses (not shown) of a pair of base plates 148 that have been welded with the ends of the suspensions 140 at both sides are swaged into a perforation hole (not shown) that perforates through both surfaces 142a₁ of the arm 142a.

Four arms 142a are mounted on the conventional carriage 142. When the number of magnetic discs is n, (n+1) arms 142a are mounted on the carriage 142, and one slider 130 is mounted on each of the uppermost arm and the lowermost arm. A pair of sliders 130 are mounted on the arm that can go in between the two adjacent magnetic discs 104.

If a plate is arranged between a pair of magnetic discs 104 in this structure, the plate would collide with the arm 142a and the suspension 140. Therefore, the plate of JP 2005-509232 and 2006-12330 is notched in an area in which the arm 142a and the suspension go. However, the notch causes the airflow or turbulence and vibrations of the disc and slider.

FIG. 5B is a schematic sectional view of a structure of this embodiment of the arm 142a, the suspension 140, and the slider 130 between the two adjacent magnetic discs 104. In order to solve the problem of FIG. 5A, this embodiment mounts the slider 130 on each arm 142a only on a single surface. The number of arms 142a mounted on the carriage 142 of the carriage 142 in this embodiment is six. When the number of magnetic discs 104 is n, 2n arms 142 are mounted on the carriage 142.

As a result, this configuration can provide an arrangement between two adjacent magnetic discs 104 in order of the magnetic disc 104, the slider 130, the arm 142a, the plate 110, the other arm 142a, the other slider 130, and the other magnetic disc 104. Since the slider 130 is mounted only on a single surface 142a₁ of each arm 142a, each arm can go in a space between the magnetic disc 104 and the plate 110, without the notch disclosed in JP 2005-509232 and 2006-12330, realizing recording and reproducing actions on opposite surfaces of two adjacent magnetic discs.

The VCM 146 has a flat coil 146b held between two yokes 146a. The flat coil 146b opposes to a magnetic circuit (not shown) provided to the housing 102, and the carriage 142 swings around the support shaft 144 in accordance with values of the current that flows through the flat coil 146b. The magnetic circuit includes, for example, a permanent magnet fixed onto an iron plate fixed in the housing 102, and a movable magnet fixed onto the carriage 142. The support shaft 144 is inserted into a cylindrical hollow in the carriage 142, and extends perpendicular to the paper surface of FIG. 1 in the housing 102.

The spindle motor 150 rotates the magnetic disc 104 at a high speed, such as 10,000 rpm, and includes a (spindle) hub 152, as shown in FIG. 2. The top surface of the hub 152 is an annular attachment surface to which the clamp ring 160 is attached. The attachment surface has plural (six in this embodiment) screw holes.

The clamp ring 160 serves to fix the discs 104 and the spacers 105 onto the spindle motor 150.

The ramp 170 is located outside the magnetic disc 104, and holds, at the stop time, a lift tab that is formed at the top of the suspension 140. The ramp 170 holds the slider 130 outside the magnetic disc 104.

### Second Embodiment

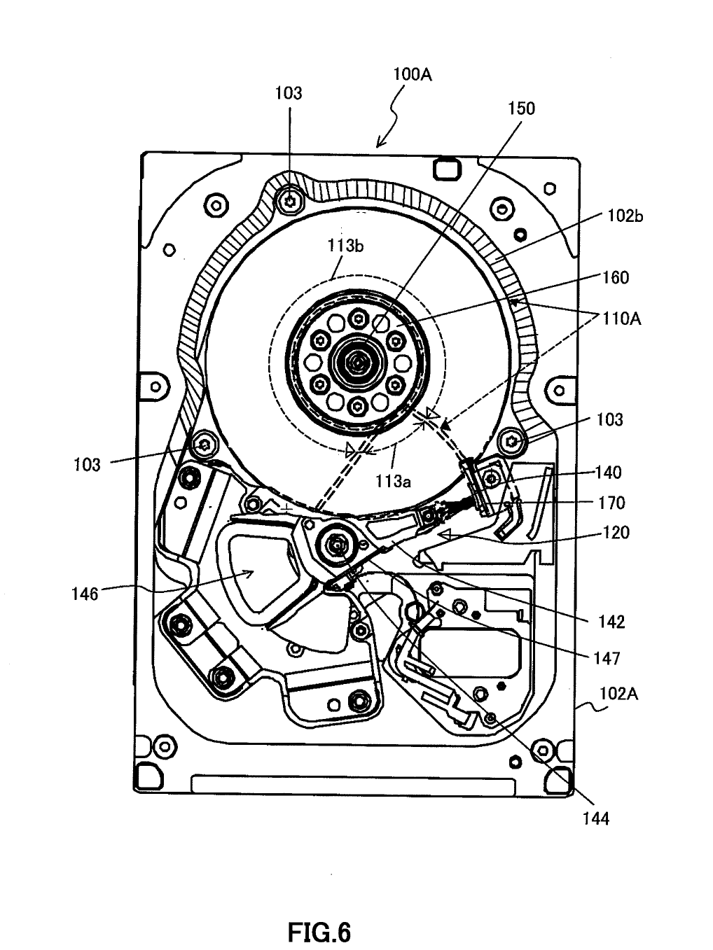

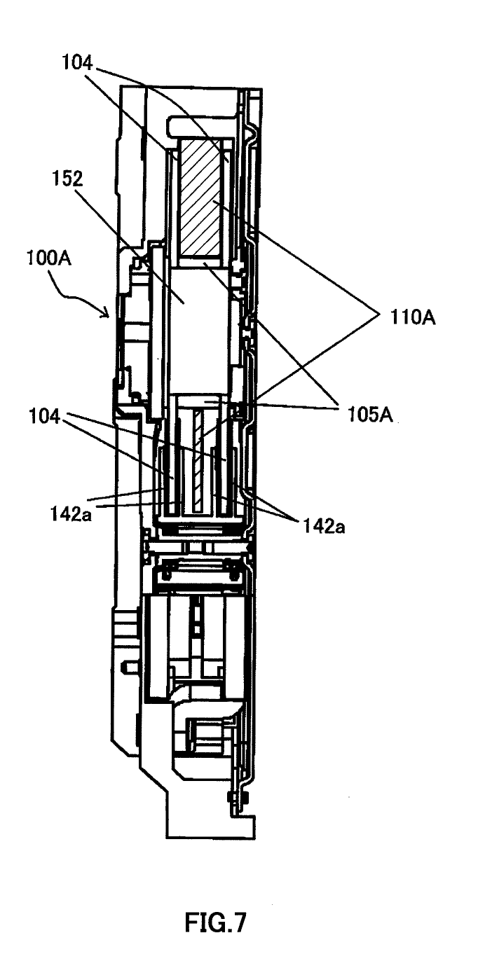

FIG. 6 is a schematic plane view of the internal structure of the HDD 100A according to a second embodiment of the present invention. FIG. 7 is a sectional view of the HDD 100A. The HDD 100A is different from the HDD 100 in that HDD 100A has a housing 102A and a plate 110A. A description will be given of the housing 102A and the plate 110A. In the HDD 100A, one spacer 105A spaces two magnetic discs 104 for convenience, but two spacers 105 may be provided to space three magnetic discs 104 similar to the first embodiment.

The housing 102A has an exhaust channel 102b of the airflow, which is hatched in FIG. 6. In a direction perpendicular to the paper plane shown in FIG. 6, the exhaust channel 102b has a height from a magnetic disc 104 located at the uppermost position shown in FIG. 7 to a magnetic disc 104 located at the lowermost position, and extends so as to cover part of the magnetic disc 104 as hatched in FIG. 6. The exhaust channel 102b facilitates an exhaust of the airflow, as described later, which airflow occurs in the space between the two adjacent magnetic discs 104. The exhaust channel 102b is connected to a notch 114a of a shroud 114 formed in the plate 110A, which will be described later.

The plate 110A is located between the two adjacent magnetic discs 104, reduces the volume of the space between them, and shields the airflow which one magnetic disc 104 generates from the airflow which the other magnetic disc 104 generates. The generated airflow reduces by reducing the volume of the space between the two adjacent magnetic discs 104, and the turbulence is prevented by preventing a mixture of the airflows. As a result, this configuration reduces or prevents vibrations of the magnetic disc 104 and the slider 130 of the HSA 120. Since this embodiment provides two magnetic discs 104, as shown in FIG. 7, one plate 110A is provided.

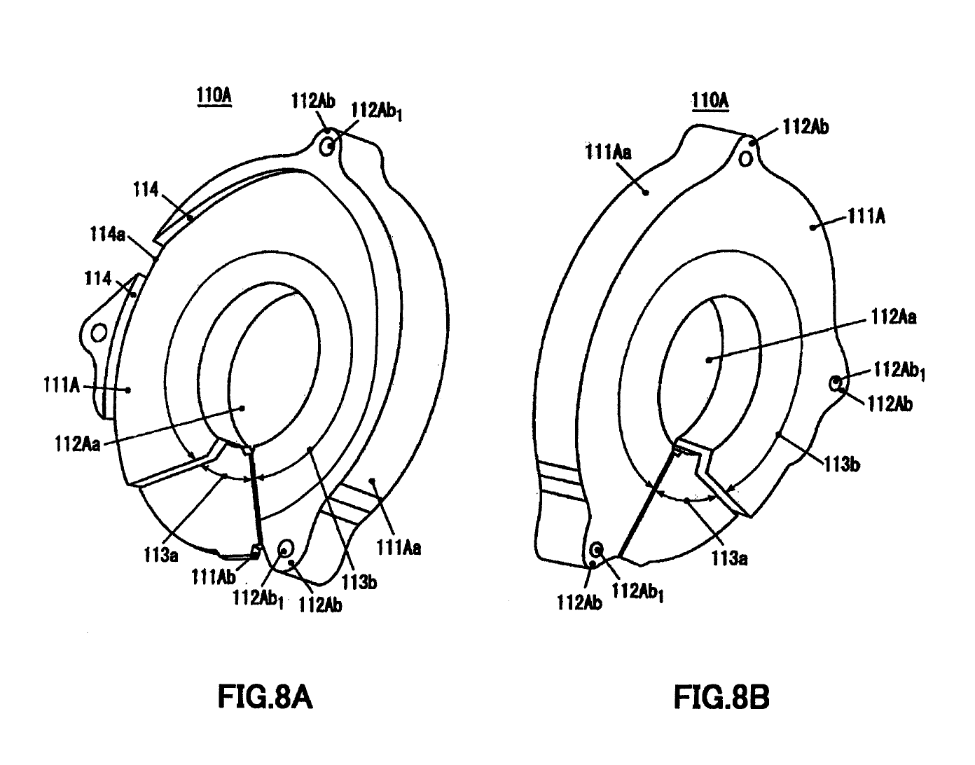

The plate 110A is fixed in the housing 102 via three screws 103, and maintained stationary relative to the rotating magnetic discs 104. FIG. 8A is a perspective view of the front side of the plate 110A. FIG. 8B is a perspective view of the rear side of the plate 110A. The plate 110A has a disc shape. The plate 110A has an annular base 111A, a perforation hole 112Aa having a thin cylindrical shape, and three attachment parts 112Ab.

The base 111A has a first area 113a in which the arm 142a and the suspension 140 can go, and a second area 113b into which the arm 142a and the suspension 140 do not go. The first area 113a is thinner than the second area 113b. In FIG. 2, in the right area in which the arm 142a and the suspension 140 do not go, a distance between the plate 110 and the adjacent magnetic disc 104 is relatively large, and this space may generate the airflow that vibrates the magnetic disc 104 and the slider 130. Accordingly, this embodiment minimizes a distance between the plate 110A and the adjacent magnetic disc 104 in the second area 113b, as shown in FIG. 8, reducing the airflow that would otherwise vibrate the magnetic disc 104 and the slider 130 in this space. A distance between the plate 110A and the adjacent magnetic disc 104 is greater than zero. The second area 113b close to the magnetic disc 104 thus reduces the space between the two adjacent magnetic discs 104, thereby lowering the airflow and the vibrations.

The base 111A has a perforation hole 112Aa at the center. Part of an outer circumference 111Aa of the base 111A has a recess 111Ab into which the ramp 170 projects. The perforation hole 112Aa is arranged around the spacer 105. The three attachment parts 112Ab are approximately triangular projections that project to the outside in radial directions from the outer circumference 111Aa of the base 111A, and have three attachment holes 112Ab₁ in each of which the screw 103 perforates. The centers of the attachment holes 112Ab₁ are arranged at regular intervals of 120° on the same circumference.

Similar to the first embodiment, the plate 110A is arranged and extends round between the two adjacent magnetic discs 104. This configuration further lowers the volume in the space between the two adjacent magnetic discs 104, and improves a ratio by which the airflow which one magnetic disc 104 generates does not mix with the airflow which the other magnetic disc 104 generates. As a result, this configuration can effectively prevent vibrations of the magnetic disc 104 and the slider 130 of the HSA 120.

The base 111A has an outer circumference edge (shroud) 114 that projects in the second area 113b. The shroud 114 has a width and height of several millimeters. The shroud 114 rectifies the airflow of the end surface (side surface) of the magnetic disc 104, and further restrains the vibration of the magnetic disc 104. The shroud 114 partially has a notch 114a. The notch 114a releases the airflow generated inside the shroud 114 to the outside, maintains the air filter effect, and improves the cooling efficiency of the VCM 146. The exhaust channel 102b of the housing 102A is connected to the notch 114a. This configuration facilitates an exhaust of the airflow.

### Third Embodiment

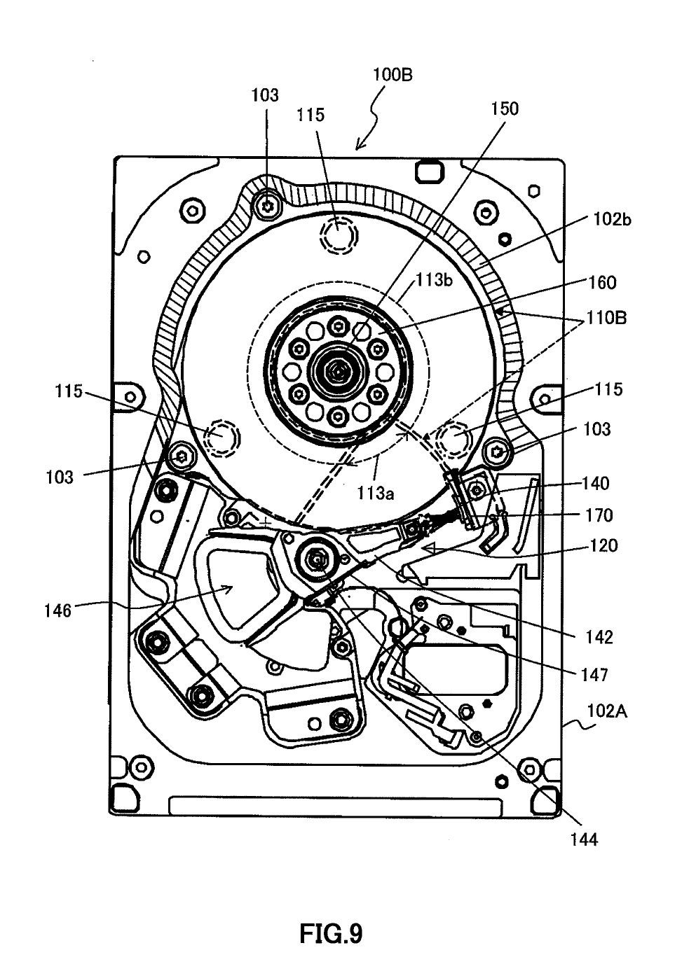

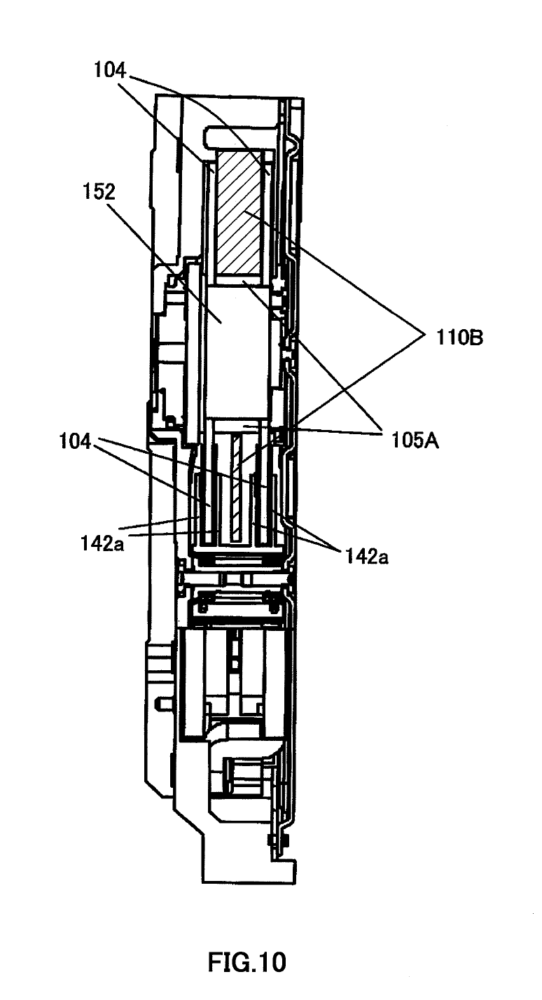

FIG. 9 is a schematic plane view of the internal structure of a HDD 100B according to a third embodiment of the present invention. FIG. 10 is a sectional view of the HDD 100B. The HDD 100B is different from the HDD 100A in that HDDB has a plate 110B. A description will now be given of the plate 110B.

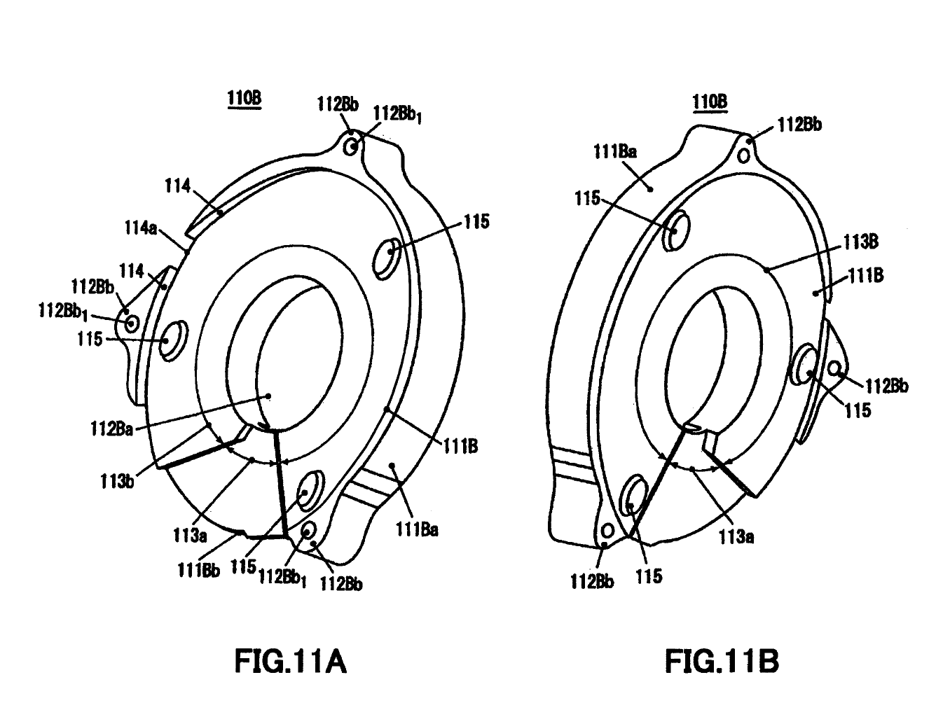

FIG. 11A is a perspective view of the front side of the plate 110B, and FIG. 11B is a perspective view of the rear side of the plate 110B. Compared with the plate 110A, the plate 110B has a base 111B that is thinner than the base 111A. The plate 110B serves similarly to the plate 110A.

The plate 110B is fixed in the housing 102 via three screws 103, and maintained stationary relative to the rotating magnetic discs 104. The plate 110B has a disc shape. The plate 110B has an annular base 111B, a perforation hole 112Ba having a thin cylindrical shape, and three attachment parts 112Bb each having an attachment hole 112Bb₁. Other than that the perforation hole 112Ba and the attachment parts 112Bb have different thicknesses, they serve similarly to the perforation hole 112Aa and the attachment parts 112Ab.

The base 111B also has a first area 113a in which the arm 142a and the suspension 140 can go, and a second area 113b in which the arm 142a and the suspension 140 do not go. The first area 113a is thinner than the second area 113b. The second area 113b close to the magnetic disc 104 can reduce the space between the two adjacent magnetic discs 104, thereby lowering the airflow and the vibrations.

Similar to the first embodiment, the plate 110B is arranged and extends round between the two adjacent magnetic discs 104. This configuration further lowers the volume in the space between the two adjacent magnetic discs 104, and improves a ratio by which the airflow which one magnetic disc 104 generates does not mix with the airflow which the other magnetic disc 104 generates. As a result, this configuration prevents or reduces vibrations of the magnetic disc 104 and the slider 130 of the HSA 120.

The base 111B has an outer circumference edge (shroud) 114 that projects in the second area 113b. The shroud 114 has a width and height of several millimeters. The shroud 114 rectifies the airflow of the end surface (side surface) of the magnetic disc 104, and can further restrains the vibration of the magnetic disc 104. The shroud 114 partially has a notch 114a. The notch 114a releases the airflow generated inside the shroud 114 to the outside, maintains the air filter effect, and improves the cooling efficiency of the VCM 146. The exhaust channel 102b of the housing 102A is connected to the notch 114a. This configuration facilitates an exhaust of the airflow.

The base 111B has three cylindrical projections 115 closest to the magnetic disc 104 in the second area 113b. The centers of the three projections 115 are arranged at regular intervals of 120° on the same circumference. The three projections 115 have the same shape and the same height. Three projections are necessary and sufficient to define a plane. It is thereby sufficient to maintain the precision of a distance between the magnetic disc 104 and the projection 115 that is the closest part to the second area 113b, and it is unnecessary to maintain the precision of a distance to the magnetic disc 104 as in the plate 110A over the entire surface of the second area 113b. Therefore, the manufacture becomes easier.

### Fourth Embodiment

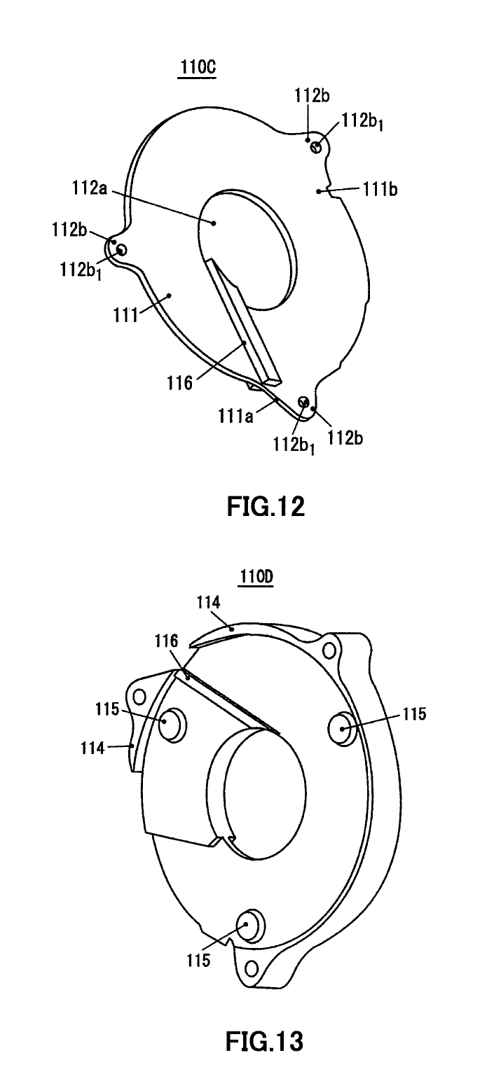

FIG. 12 is a perspective view of the rear side of a plate 110C applicable to the HDD 100 according to a fourth embodiment of the present invention. The plate 110C is different from the plate 110 in that the plate 110C has a projection 116. The projection 116 extends from the perforation hole 112a to the outer circumference 111a. This configuration releases the airflow the outside, maintains the air filter effect, and improves the cooling efficiency of the VCM 146. The projection 116 can extend in the tangential direction of the perforation hole 112a, because the air flows in this direction.

### Fifth Embodiment

FIG. 13 is a perspective view of the front side of a plate 110D applicable to the HDD 100 according to a fifth embodiment of the present invention. The plate 110D is different from the plate 110B in that the plate 110D has the projection 116.

In operation of the HDD 100, a control part (not shown) drives the spindle motor 150 and rotates the discs 104. The airflow associated with the rotation of the magnetic disc 104 is introduced between the disc 104 and slider 130, forming a micro air film and thus generating the floating force that enables the slider 130 to float over the disc surface. On the other hand, the suspension 140 applies an elastic force onto the slider 130 in a direction against the floating force of the slider 130. The balance between the floating force and the elastic force spaces the slider 130 from the magnetic disc 104 by a constant distance. At this time, the plate 110 prevents a generation of an unnecessary airflow, lowering the vibrations of the magnetic disc 104 and the slider 130.

Next, the control part rotates the carriage 142 around the support shaft 144 so as to seek the head 132 for a target track on the disc 104. Since the arm 142a is mounted with only one slider 130, the arm 42a and the suspension 140 do not collide with the plate 110. In write time, the control part receives data from a host (not shown), such as a PC, through an interface, selects the inductive head device, and sends modulated data as write current to the inductive head device. Thereby, the inductive head device writes down the data onto the target track. In read time, the control part selects the MR head device, and sends the sense current. Thereby, the MR head device reads data from desired track on the disc 104.

When a position error signal (“PES”) spectrum of the HDD 100 is compared with the PES spectrum of the HDD that does not have the plate 110 of this embodiment, the head of the HDD 100 is expected to improve a non-repeatable run-out (“NRRO”) by about 9% in a numerical comparison. Moreover, the HDD 100A and the HDD 100 use the plate 110A close to the magnetic disc 104, and reduces a medium vibration component, and can expect a NRRO improvement by about 20% as a whole.

Thus, according to the above embodiments, the plate reduces the vibrations of the magnetic disc 104 and the slider 130, and provides a high head positioning function.

While the above embodiments describe the magnetic disc drive, the present invention is applicable to an optical disc drive that adopts a slider mounting method with a head for an optical disc or a magneto-optical disc.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-234282, filed Sep. 10, 2007, which is hereby incorporated by reference herein in its entirety.

What is claimed is:

1. A storage device comprising:
plural recording media;
a housing configured to accommodate the plural recording media;
a plate that is fixed and extends round between two adjacent recording media in the housing;
plural sliders each of which is mounted with a magnetic head that is configured to record information in or reproduce the information from a corresponding one of the plural recording media; and
plural arms, each of which is mounted with one of the plural sliders only on a single surface, and configured to move the one of the plural sliders.

2. The storage device according to claim 1, wherein the plate has a plate shape.

3. The storage device according to claim 1, wherein the plate has a first area in which the arm goes, and a second area in which the arm does not go, the first area being thinner than the second area.

4. The storage device according to claim 3, wherein the plate has a projection in the second area, which projection is closest to a corresponding one of the recording media.

5. The storage device according to claim 3, wherein the plate has a projecting outer edge in the second area.

6. The storage device according to claim 5, wherein part of the projecting outer edge has a notch.

7. The storage device according to claim 6, wherein the housing has an exhaust channel that is connected to the notch and encloses part of a corresponding one of the recording media.

8. The storage device according to claim 1, wherein the housing has an exhaust channel that extends parallel to a tangential direction of each recording media.

9. The storage device according to claim 1, wherein the plate has a cylindrical perforation hole, and the plate has a projection that extends from the cylindrical perforation hole to an outer circumference.

10. The storage device according to claim 3, wherein the plate has a cylindrical perforation hole, and the plate has a projection in the second area, which extends from the cylindrical perforation hole to an outer circumference.

11. The storage device according to claim 9, wherein the projection extends in a tangential direction of the cylindrical perforation hole.
